(19) United States
(12) Patent Application Publication
(10) Pub. No.: US 2009/0248353 A1
(43) Pub. Date: Oct. 1, 2009

(54) SYSTEM AND METHOD FOR SIMULATING MOVEMENT OF AN IMAGE MEASURING MACHINE

(75) Inventors: CHIH-KUANG CHANG, Tu-Cheng (TW); YI-RONG HONG, Shenzhen City (CN); ZHONG-KUI YUAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/261,041

(22) Filed: Oct. 30, 2008

(30) Foreign Application Priority Data
Mar. 25, 2008 (CN) 200810300696.4

(51) Int. Cl. G01B 5/008

(52) U.S. Cl. 702/152

(57) ABSTRACT

A method for simulating movement of an image measuring machine is provided. The method includes obtaining vertex coordinates of the image measuring machine and features that need to be generated, creating an initial model of the image measuring machine. The features comprise parts of a top cover, a lens, a workplace, and a holder of the image measuring machine. The method further includes obtaining a displacement of each part of the image measuring machine, calculating new vertex coordinates of each part, generating the features of the top cover, the lens, the workplace, and the holder according to the new vertex coordinates, so as to create a new model of the image measuring machine, and displaying the new model of the image measuring machine on a display device.

### BACKGROUND

1. Field of the Invention

Embodiments of the present disclosure relate to systems and methods for measuring images, and particularly to a system and method for simulating movement of an image measuring machine.

2. Description of Related Art

Measurement is an important phase in the manufacturing process and is closely interrelated to the product quality of an object. Generally, an engineer will use an image measuring machine to obtain an electronic image of an object. The image is stored in a computer and may be shown on a display device, where a program is used to determine precision of the object according to data of pixel points in the image.

However, in the traditional method, the electronic image only includes a model of the object and a static model of the image measuring machine. If one or more parts of the image measuring machine are moved, the model of the image measuring machine is not changed in the electronic image. It is inconvenient for the user to observe a position of the object relative to the image measuring machine.

What is needed, therefore, is a system and method for simulating movement of an image measuring machine.

### SUMMARY

A computer-implemented method for simulating movement of an image measuring machine is provided. The method includes: reading a configuration file from a storage device of a computer, wherein the configuration file stores all initial vertex coordinates of the image measuring machine and features that need to be generated, the features comprising parts of a top cover, a lens, a workplace, and a holder of the image measuring machine; generating the features of the top cover, the lens, the workplace, and the holder using graphical interfaces according to the initial vertex coordinates, so as to create an initial model of the image measuring machine; obtaining a displacement of each part of the image measuring machine when one or more parts of the image measuring machine are moved; calculating new vertex coordinates of each part of the image measuring machine according to the initial vertex coordinates of each part and the displacement, wherein the new vertex coordinates comprise vertex coordinates of the top cover, the lens, the workplace, or the holder; generating the features of the top cover, the lens, the workplace, and the holder using graphical interfaces according to the new vertex coordinates, so as to create a new model of the image measuring machine; displaying the new model of the image measuring machine on a display device.

Other systems, methods, features, and advantages of the present disclosure will become apparent to one with ordinary skill in the art upon examination of the following drawings and detailed description.

### BRIEF DESCRIPTION OF THE DRAWINGS

FIG. 1 is a block diagram of one embodiment of a system for simulating movement of an image measuring machine;

FIG. 2 is a flowchart of one embodiment of a method for simulating movement of an image measuring machine; and

FIG. 3 is a schematic diagram of a model of one embodiment of an image measuring machine.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware. Depending on the embodiment, the computer-readable medium may be a hard disk drive, a compact disc, a digital video disc, or a tape drive.

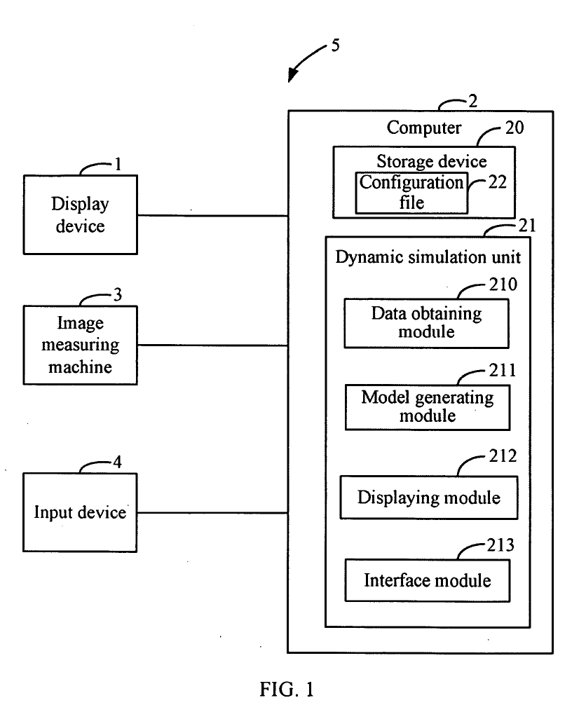

FIG. 1 is a block diagram of one embodiment of a system 5 for simulating movement of an image measuring machine 3. In one embodiment, the system 5 includes a display device 1, a computer 2, the image measuring machine 3, and an input device 4. The display device 1, the image measuring machine 3, and the input device 4 are electronically connected to the computer 2. Depending on the embodiment, the display device 1 may be a computer display, a monitor, a television, for example.

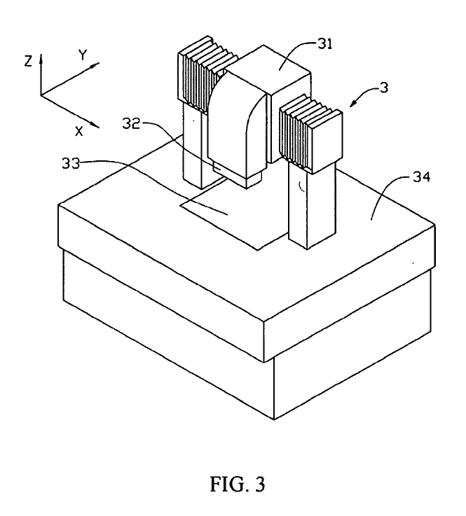

A schematic diagram of a model of one embodiment of the image measuring machine 3 is shown in FIG. 3. In one embodiment, the model of the image measuring machine 3 includes parts of a top cover 31, a lens 32, a workplace 33, and a holder 34. It may be understood that the embodiment of the image measuring machine 3 as illustrated in FIG. 3 is exemplary and may include other image measuring machines having the same and/or more or less features as will be explained further herein.

The computer 2 includes a storage device 20 and a dynamic simulation unit 21. A configuration file 22 stored in the storage device 20 stores all initial vertex coordinates of the image measuring machine 3 and features that need to be generated in a digital audio tape (DAT) file. For example, depending on the embodiment, the features comprise parts of the top cover 31, the lens 32, the workplace 33, and the holder 34 of the image measuring machine 3. The features of the top cover 31 may include lines, planes, circles, ellipses, B-spline curves, B-spline surfaces, and rotatable objects.

The dynamic simulation unit 21 is configured for generating an initial model of the image measuring machine 3 according to the initial vertex coordinates of the image measuring machine 3 stored in the configuration file 22.

The dynamic simulation unit 21 is further configured for automatically obtaining a displacement of each part of the image measuring machine 3 when one or more parts of the image measuring machine 3 are moved, calculating new vertex coordinates of each part according to the initial vertex coordinates of each part and the displacement, generating the features according to the new vertex coordinates, so as to create a new model of the image measuring machine 3, and displaying the new model of the image measuring machine 3 on the display device 1.

The image measuring machine 3 captures images of an object, and sends the images to the computer 2.

The input device 4 is provided for manually moving one or more parts of the image measuring machine 3, e.g., moving along an X-axis, moving along a Y-axis, or moving along a Z-axis. The input device 4 may be a keyboard or a mouse although the disclosure is not limited thereto.

In one embodiment, the dynamic simulation unit 21 includes a data obtaining module 210, a model generating module 211, a displaying module 212, and a interface module 213. The modules 210, 211, 212, and 213 may be used to execute one or more operations of the dynamic simulation unit 21.

The data obtaining module 210 is configured for reading the configuration file 22 from the storage device 20. As mentioned above, the configuration file 22 stores all initial vertex coordinates of the image measuring machine 3 and the features that need to be generated. The initial vertex coordinates include vertex coordinates of the top cover 31, the lens 32, the workplace 33, and the holder 34.

The model generating module 211 is configured for generating the features of the top cover 31, the lens 32, the workplace 33, and the holder 34 using graphical interfaces according to the initial vertex coordinates, so as to create an initial model of the image measuring machine.

The model generating module 211 is further configured for obtaining a displacement of each part of the image machine 3 when the one or more parts of the image measuring machine 3 are moved. For example, the top cover 31 can be moved along the X-axis, the lens 32 can be moved along the X-axis and the Z-axis, and the workplace 33 can be moved along the Y-axis. When the top cover 31 moves along the X-axis, the lens 32 also moves along the X-axis.

The model generating module 211 is further configured for calculating new vertex coordinates of each part of the image measuring machine 3 according to the initial vertex coordinates of each part and the displacement. The new vertex coordinates include new vertex coordinates of the top cover 31, the lens 32, the workplace 33, or the holder 34. For example, the initial vertex coordinates of the lens 32 are as follows: (10, 12, 14), (18, 12, 14), (10, 14, 14), (18, 14, 14) . . . (take millimeter (mm) as a displacement unit). If the lens 32 moves one millimeter along a positive direction of the Z-axis, the model generating module 211 obtains the displacement (i.e., one millimeter) of the lens 32, adding one millimeter to each value of the Z-axis coordinate of the lens 32, thereby generating the new vertex coordinates of the lens 32, such as follows: (10, 12, 15), (18, 12, 15), (10, 14, 15), (18, 14, 15), . . . .

The model generating module 211 is further configured for generating the features of the top cover 31, the lens 32, the workplace 33, and the holder 34 using graphical interfaces according to the new vertex coordinates, so as to create the new model of the image measuring machine 3.

The displaying module 212 is configured for displaying all the features to show the new model of the image measuring machine 3 on the display device 1.

The interface module 213 is configured for providing the graphical interfaces for the model generating module 211. The graphical interfaces are graphical functions for generating different features in an image processing software (e.g., Open Graphics Library, OpenGL). In one embodiment, the interface module 213 includes a texture interface for loading texture, a point interface for generating point features, a line interface for generating line features, a plane interface for generating flat features, a circle interface for generating circular features, an ellipse interface for generating elliptical features, a B-spline curve interface for generating B-spline features, a B-spline surface interface for generating B-spline surfaces, and a rotatable object interface for generating rotatable object features.

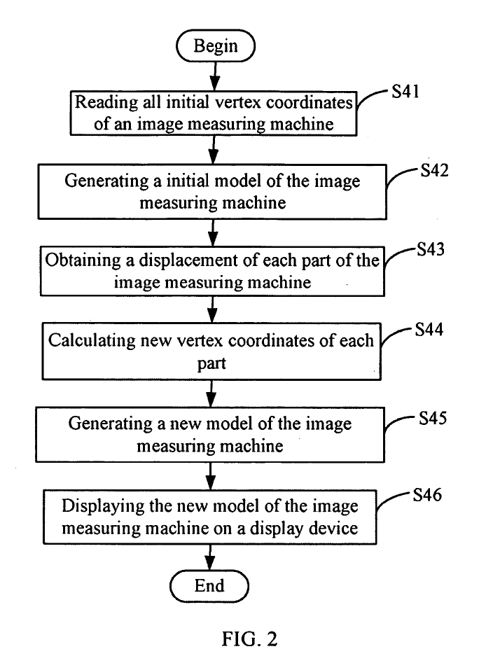

FIG. 2 is a flowchart of one embodiment of a method for simulating movement of an image measuring machine. Depending on the embodiment, additional blocks may be added, others removed, and the ordering of the blocks may be changed.

In block S41, the data obtaining module 210 reads the configuration file 22 from the storage device 20. The configuration file 22 stores all initial vertex coordinates of the image measuring machine 3 and features that need to be generated. In one embodiment, the features comprises parts of the top cover 31, the lens 32, the workplace 33, and the holder 34 of the image measuring machine 3. The initial vertex coordinates comprise vertex coordinates of the top cover 31, the lens 32, the workplace 33, and the holder 34.

In block S42, the model generating module 211 generates the features of the top cover 31, the lens 32, the workplace 33, and the holder 34 using graphical interfaces according to the initial vertex coordinates, so as to create an initial model of the image measuring machine 3.

In block S43, the model generating module 211 obtains a displacement of each part of the image measuring machine 3 when one or more parts of the image measuring machine 3 are moved.

In block S44, the model generating module 211 calculates new vertex coordinates of each part of the image measuring machine 3 according to the initial vertex coordinates of each part and the displacement. The new vertex coordinates include vertex coordinates of the top cover 31, the lens 32, the workplace 33, and the holder 34.

In block S45, the model generating module 211 generates the features of the top cover 31, the lens 32, the workplace 33, and the holder 34 using graphical interfaces according to the new vertex coordinates, so as to create a new model of the image measuring machine 3. The graphical interfaces are provided by the interface module 213.

In block S46, the displaying module 212 displays all the features to show the new model of the image measuring machine 3 on the display device 1.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for simulating movement of an image measuring machine, the method comprising:
reading a configuration file from a storage device of a computer, wherein the configuration file stores all initial vertex coordinates of the image measuring machine and features that need to be generated, the features comprising parts of a top cover, a lens, a workplace, and a holder of the image measuring machine;
generating the features of the top cover, the lens, the workplace, and the holder using graphical interfaces according to the initial vertex coordinates, so as to create an initial model of the image measuring machine;
obtaining a displacement of each part of the image measuring machine when one or more parts of the image measuring machine are moved;
calculating new vertex coordinates of each part of the image measuring machine according to the initial vertex coordinates of each part and the displacement, wherein the new vertex coordinates comprise vertex coordinates of the top cover, the lens, the workplace, or the holder;
generating the features of the top cover, the lens, the workplace, and the holder using graphical interfaces according to the new vertex coordinates, so as to create a new model of the image measuring machine; and
displaying the new model of the image measuring machine on a display device.

2. The method according to claim 1, wherein a movement of each part of the image measuring machine is selected from the group consisting of an X-axis movement, a Y-axis movement, and a Z-axis movement.

3. The method according to claim 1, wherein the graphical interfaces are graphical functions for generating different features.

4. The method according to claim 1, wherein the graphical interfaces comprise a texture interface for loading texture, a point interface for generating point features, a line interface for generating line features, a plane interface for generating flat features, a circle interface for generating circular features, an ellipse interface for generating elliptical features, a B-spline curve interface for generating B-spline curves, a B-spline surface interface for generating B-spline surfaces, and a rotatable object interface for generating rotatable object features.

5. A computer-readable medium having stored thereon instructions that, when executed by a computer, causing the computer to:
read a configuration file from a storage device of a computer, wherein the configuration file stores all initial vertex coordinates of the image measuring machine and features that need to be generated, the features comprising parts of a top cover, a lens, a workplace, and a holder of the image measuring machine;
generating the features of the top cover, the lens, the workplace, and the holder using graphical interfaces according to the initial vertex coordinates, so as to create an initial model of the image measuring machine;
obtain a displacement of each part of the image measuring machine when one or more parts of the image measuring machine are moved;
calculate new vertex coordinates of each part of the image measuring machine according to the initial vertex coordinates of each part and the displacement, wherein the new vertex coordinates comprise vertex coordinates of the top cover, the lens, the workplace, or the holder;
generate the features of the top cover, the lens, the workplace, and the holder using graphical interfaces according to the new vertex coordinates, so as to create a new model of the image measuring machine; and
display the new model of the image measuring machine on a display device.

6. The computer-readable medium according to claim 5, wherein computer-readable medium is selected from the group consisting of a hard disk drive, a compact disc, a digital video disc, and a tape drive.

7. The computer-readable medium according to claim 5, wherein a movement of each part of the image measuring machine is selected from the group consisting of an X-axis movement, a Y-axis movement, and a Z-axis movement.

8. A computing system for simulating movement of an image measuring machine, comprising:
a configuration file stored in a storage device of a computer connected to the image measuring machine, wherein the configuration file stores all initial vertex coordinates of the image measuring machine and features that need to be generated, the features comprising parts of a top cover, a lens, a workplace, and a holder of the image measuring machine; and
a dynamic simulation unit configured for:
generating the features of the top cover, the lens, the workplace, and the holder using graphical interfaces according to the initial vertex coordinates, so as to create an initial model of the image measuring machine;
obtaining a displacement of each part of the image measuring machine when one or more parts of the image measuring machine are moved, and calculating new vertex coordinates of each part of the image measuring machine according to the displacement;
generating the features of the top cover, the lens, the workplace, and the holder using graphical interfaces according to the new vertex coordinates, so as to create a new model of the image measuring machine; and
displaying the new model of the image measuring machine on a display device.

9. The system according to claim 8, wherein a movement of each part of the image measuring machine is selected from the group consisting of an X-axis movement, a Y-axis movement, and a Z-axis movement.

10. The system according to claim 8, wherein the graphical interfaces are graphical functions for generating different features.
